(19) United States
(12) Patent Application Publication
(10) Pub. No.: US 2002/0111200 A1
(43) Pub. Date: Aug. 15, 2002

(54) Power reducing apparatus and method for portable terminal equipped with display unit

(76) Inventors: Susumu Nikawa, Kawasaki (JP); Minoru Sakata, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/923,054

(22) Filed: Aug. 6, 2001

(30) Foreign Application Priority Data
Feb. 9, 2001 (JP) 2001-34496

(51) Int. Cl. H04M 1/00

(52) U.S. Cl. 455/574; 455/343; 455/566

(57) ABSTRACT

Relates to a portable terminal, and particularly provides a terminal that achieves a reduction in unnecessary power consumption in an LCD display unit held in a mobile communication portable terminal. A power reducing apparatus for the portable terminal equipped with a display unit is structured by: DC/DC converter for supplying power to the display unit; a frequency switching unit for selectively switching and supplying one of a plurality of switching clock frequencies to the DC/DC converter; and a display mode detecting unit for detecting that the display unit has been switched to a predetermined low-power consumption mode, determining one of the plurality of switching clock frequencies according to power consumption reduced in the predetermined low-power consumption mode based on this detection, and instructing the frequency switching unit to execute this selective switching.

### BACKGROUND OF THE INVENTION

1. Field of the Invention

The present invention relates to a portable terminal and, more particularly, to a power reducing apparatus and a method therefor relevant to an LCD display unit held in a mobile communication portable terminal.

2. Description of the Related Art

In the use of a mobile communication portable terminal like a portable telephone, most of the time is occupied by waiting for reception of a call or a mail as compared with the time spent transmitting/receiving calls to/from users or receiving mails or carrying out data communications via the Internet. From the viewpoint of the convenience of users of the mobile communication portable terminals, power saving of these terminals during the waiting time is most important.

FIG. 1 shows an example of a basic block structure of a mobile communication portable terminal.

Referring to FIG. 1, a mobile communication portable terminal 10 carries out communications with a mobile base station using a radio circuit 15 via an antenna 16. A CPU 13 manages the operation of a terminal unit as a whole including the communication processing, and also carries out a user interface processing based on input/output units 14 including a key input unit, a speaker, and a microphone, and a display unit 12. The mobile communication portable terminal 10 itself operates using batteries 11 of which power source is managed.

FIG. 2 shows one example of a structure of a conventional LCD (Liquid Crystal Display) unit.

Referring to FIG. 2, a display controller 24 stores display data from a CPU 13 in a display RAM 26. A controller 25 drives a driver A 22 and a driver B 23 to display the display data stored in the display RAM on an LCD panel 21, based on an instruction from the CPU 13.

A power source unit 27 including a DC/DC converter carries out a switching operation based on an oscillation clock from a frequency oscillation circuit 28. The power source unit 27 boosts the voltage of the batteries 11 shown in FIG. 1 from about 3.4 V to about 10 V that is necessary for operating the LCD panel 21, and supplies the boosted voltage to the LCD panel 21.

FIG. 3 shows one example of current consumed at main portions of the mobile communication portable terminal 10. As shown in FIG. 3, the current consumed in the LCD display is 360 μA, which is about a quarter of the total power consumed in the terminal unit. Therefore, when power is saved, particularly in the LCD display during the waiting time of the mobile communication portable terminal, this has a large effect in the total power saving of the portable terminal.

At present, most of the mobile communication portable terminals have a display as shown in FIG. 1. An LCD is used as a main display unit. In pursuit of improvement in the quality and performance of the LCD, the demand for the LCD has rapidly changed from a monochromatic LCD to a color LCD. However, there has been a problem in that, in general, the color LCD consumes more current than the monochromatic LCD.

Conventionally, the following two methods have been used for reducing the power consumption of a mobile communication portable terminal equipped with an LCD display unit during its waiting time. One method is that the number of colors displayed by the LCD is decreased from about 160 thousand colors to 256 colors, when there is no key input to the mobile communication portable terminal during a predetermined continuous time period. The other method is a partial display method that power is supplied to a minimum necessary display portion, and power supply to other portions is decreased, when there is no key input to the mobile communication portable terminal during a predetermined continuous time period.

It is possible to obtain a certain level of power saving effect according to these two methods. However, these two methods have had a problem in that the operation efficiency of the DC/DC converter of the power source unit 27 shown in FIG. 2 is lowered.

In general, a DC/DC converter of a type built in a device is designed to operate best during the normal operation of the device. When an output current after boosting becomes lower than a preset operation level, an unnecessary level of current is generated inside the booster circuit. As a result, the power conversion efficiency is lowered suddenly. According to methods other than the above two methods, a current level necessary for the LCD display is also decreased due to a limitation of the number of display colors and a partial display. As a result, a current level necessary after a boosting is lowered, and an unnecessary level of current is generated inside a DC/DC converter.

### SUMMARY OF THE INVENTION

In the light of the above problems, it is, therefore, an object of the present invention to eliminate unnecessary power consumption and to achieve a further reduction in power consumption during a waiting time of a display unit and/or a mobile communication portable terminal including a display unit, based on a provision of a unit for maintaining a maximum efficiency of a DC/DC converter even when a display status of the display unit has changed from a normal operation mode to a waiting mode.

According to one aspect of the present invention, there is provided a portable terminal equipped with a display unit, the portable terminal comprising: a DC/DC converter for supplying power to the display unit; a frequency switching unit for selectively switching and supplying one of a plurality of switching clock frequencies to the DC/DC converter; and a display mode detecting unit for detecting that the display unit has been switched to a predetermined low-power consumption mode, determining one of the plurality of switching clock frequencies according to power consumption reduced in the predetermined low-power consumption mode based on this detection, and instructing the frequency switching unit to execute this selective switching.

According to another aspect of the present invention, there is provided a method of reducing power consumption of a portable terminal equipped with a display unit to which power is supplied from a DC/DC converter, the method comprising the steps of: monitoring the display unit to see whether the display unit is in a display color number limiting mode or in a partial display mode; determining a switching clock frequency of the DC/DC converter according to power consumption reduced by a reduction in the number of display colors or a reduction in a display area, when the display color number limiting mode or the partial display mode has been detected; and switching the frequency to the determined switching clock frequency, and operating the DC/DC converter at this frequency.

### BRIEF DESCRIPTION OF THE DRAWINGS

The present invention will be more clearly understood from the description as set forth below with reference to the accompanying drawings.

FIG. 1 is a diagram showing an example of a basic block structure of a mobile communication portable terminal.

FIG. 2 is a diagram showing one example of a structure of a conventional LCD unit.

FIG. 3 is a diagram showing one example of current consumed at main portions of a mobile communication portable terminal.

FIG. 4 is a diagram showing an example of a basic block structure of an LCD unit according to the present invention.

FIG. 5 is a diagram showing an example of a detailed block structure of a display controller 24 shown in FIG. 4.

FIG. 6 is a diagram showing one example of a DC/DC converter for carrying out a switching operation according to the present invention.

FIG. 7A is an explanatory diagram of operation (1) of the DC/DC converter shown in FIG. 6.

FIG. 7B is an explanatory diagram of operation (2) of the DC/DC converter shown in FIG. 6.

FIG. 8 is a diagram showing one example of the efficiency of a DC/DC converter according to the present invention in comparison with the efficiency of a DC/DC converter according to a conventional technique.

FIG. 9 is a flowchart showing one example of a process of limiting the number of display colors according to the present invention.

FIG. 10 is a flowchart showing one example of a process of carrying out a partial display according to the present invention.

### BRIEF DESCRIPTION OF THE PREFERRED EMBODIMENTS

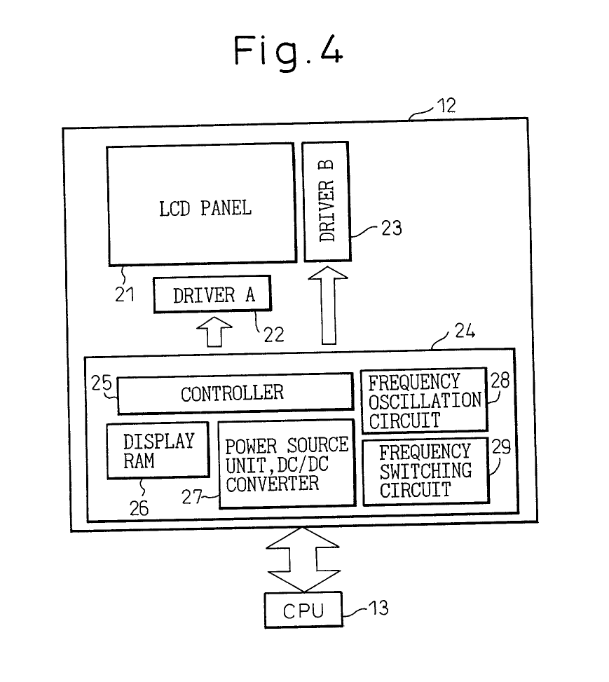

FIG. 4 is a diagram showing an example of a basic block structure of an LCD unit according to the present invention.

Referring to FIG. 4, a display controller 24 stores display data from a CPU 13 in a display RAM 26. A controller 25 drives a driver A 22 and a driver B 23 to display the display data stored in the display RAM on an LCD panel 21, based on an instruction from the CPU 13.

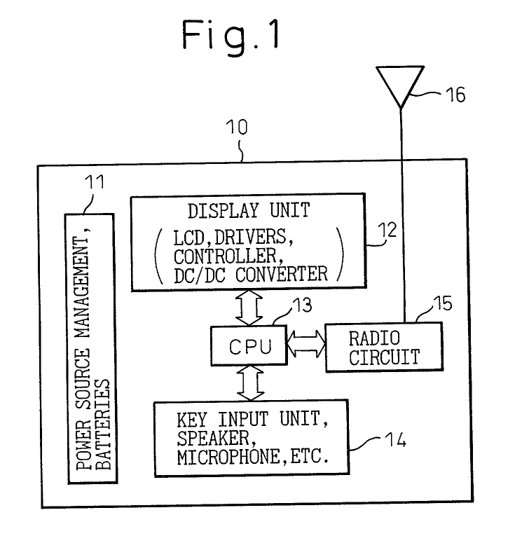

A power source unit 27 including a DC/DC converter carries out a switching operation based on an oscillation clock from a frequency oscillation circuit 28. The power source unit 27 boosts the voltage of the batteries 11 shown in FIG. 1 from about 3.4 V to the about 10 V that is necessary for operating the LCD panel 21, and supplies the boosted voltage to the LCD panel 21.

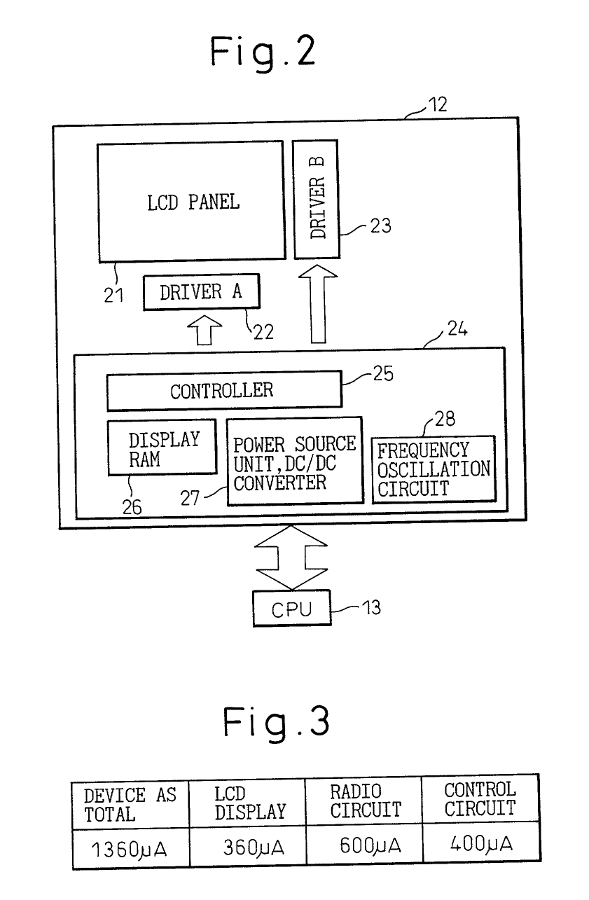

The structure of the LCD display unit shown in FIG. 4 is similar to that of the conventional example shown in FIG. 2, except that a frequency switching circuit 29 is additionally provided in FIG. 4. Therefore, the frequency switching circuit 29 and relevant circuits will mainly be explained below.

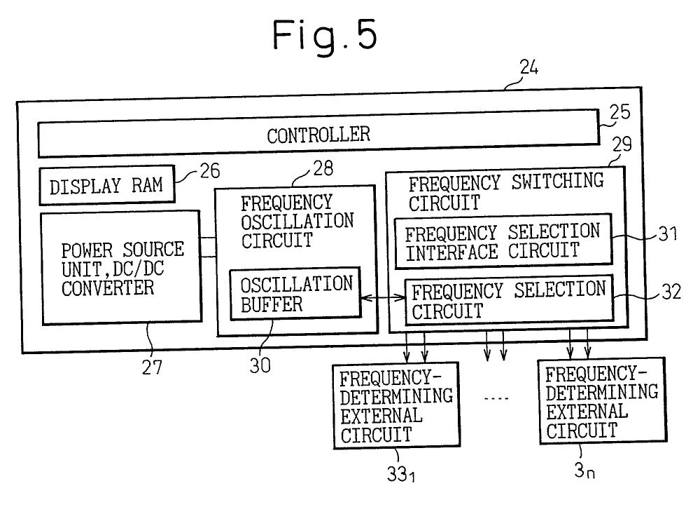

FIG. 5 shows constituents of the display controller 24 shown in FIG. 24, and this particularly shows one example of a detailed block structure of the frequency switching circuit 29. As shown in the drawing, the present invention is realized by disposing the circuits that selectively supply a clock frequency for controlling the switching of the DC/DC converter in the controller, in the conventional structure of the LCD display unit consisting of a liquid crystal panel, drivers, and a controller.

In the present example, a general LC type Colpitts oscillation circuit is used as the frequency oscillation circuit 28 for the DC/DC converter that is built into the LCD panel. Capacities for determining a plurality of oscillation frequencies of the Colpitts oscillation circuit are accommodated in frequency-determining external circuits 331 to 33n at the frequency switching circuit 29 side. Capacities C1 to Cn are accommodated in these external circuits.

A frequency selection interface circuit 31 controls a frequency selecting circuit 32 to select one of the frequency-determining external circuits 331 to 33n, based on an instruction from the CPU 13. It is possible to structure the frequency selection interface circuit 31 and the frequency selecting circuit 32 easily by using logical selectors and analog switches. The oscillation frequency of the Colpitts oscillation circuit is determined based on this selection of an external circuit. A capacity Cn selected by the frequency-determining external circuits 331 to 33n is connected to a capacity connection terminal of the Colpitts oscillation circuit at the frequency oscillation circuit 28 side, via an oscillation buffer 30.

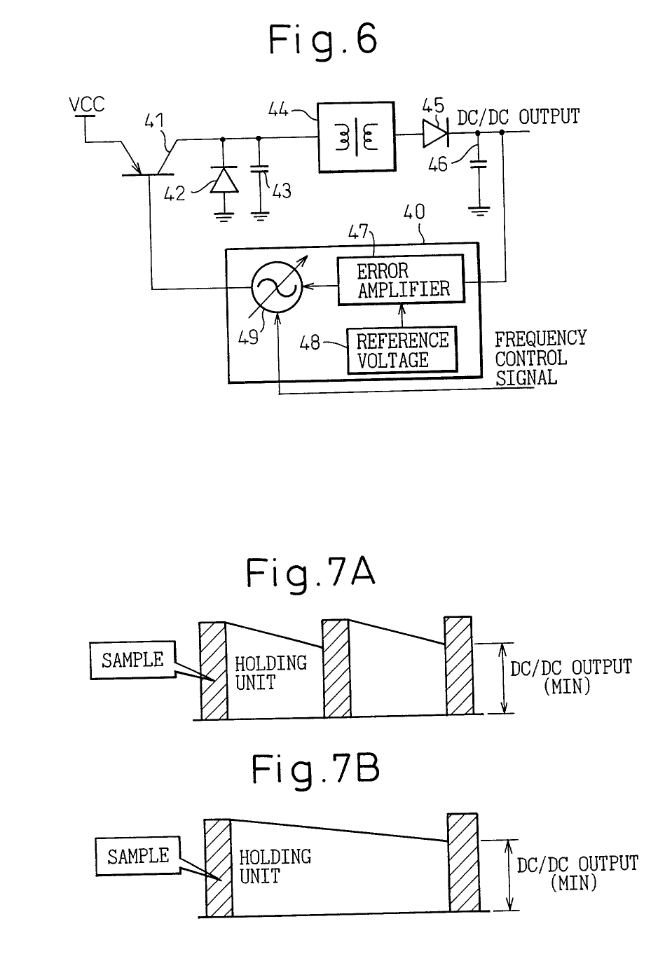

FIG. 6 and FIGS. 7A and 7B schematically show examples of a DC/DC converter for carrying out the switching operation according to the present invention.

A transistor 41 chops a battery voltage (VCC) of 3.6 V, for example, based on a clock signal generated from a DC/DC controller 40. A chopped signal is boosted, by a step-up transformer 44, by about three times to a power source voltage of 10 V that is necessary at the LCD side. The boosted signal is smoothed by a diode 45 and a capacitor 46, and a DC output is supplied to the LCD side as a DC supply voltage 10 V.

An error amplifier 47 and a reference potential 48 of the DC/DC controller 40 are provided for fixing the voltage of the output voltage in a similar manner to that of the conventional practice. An oscillator 49 shown in FIG. 6 corresponds to a combination of the frequency oscillation circuit 28, the frequency switching circuit 29, and the frequency-determining external circuits 331 to 33n shown in FIG. 5. The whole DC/DC converter circuit is included in the power source unit 27 shown in FIG. 5.

FIGS. 7A and 7B show examples of a characteristic DC/DC converter operation according to the present invention in the circuit shown in FIG. 6. FIG. 7A shows an example of a DC/DC output when the LCD panel 21 shown in FIG. 4 is driven in a normal display mode. FIG. 7B shows an example of a DC/DC output when the LCD panel 21 is driven in a display status during a waiting time when the number of display colors is limited or when a partial display is carried out.

In the case of the operation shown in FIG. 7A, a voltage fall during a holding time is large, as a large amount of current is supplied to the LCD side. Therefore, it is necessary to shorten the sampling period in order to satisfy a supply voltage DC/DC output (MIN) that is necessary as a minimum for driving the LCD panel 21. On the other hand, in the case of the operation shown in FIG. 7B, a voltage fall during a holding time is small, as the current to be supplied to the LCD side has been reduced by limiting the number of display colors or based on a partial display. Therefore, the sampling period for satisfying the same supply voltage DC/DC output (MIN) becomes longer.

According to the present invention, the switching of the clock frequency between the operation shown in FIG. 7A and operation shown in FIG. 7B is carried out according to an instruction from an external CPU 13 shown in FIG. 4. In this case, the efficiency of the DC/DC converter is improved substantially when the clock period in FIG. 7B is set longer. As shown in slanted lines in FIG. 7A and FIG. 7B, at each sampling time, a switching current is consumed at a primary side of the step-up transformer 44, regardless of the size of an output current at a secondary side. It is possible to avoid the unnecessary current consumption at the primary side, by making the clock period longer, or by decreasing the rate of sampling.

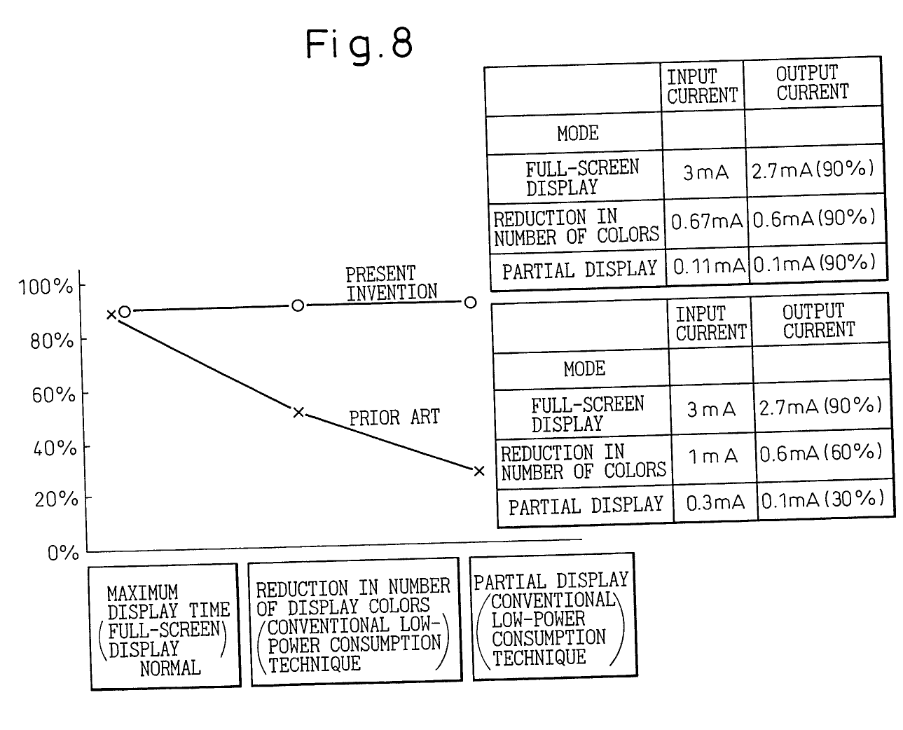

FIG. 8 shows one example of the efficiency of a DC/DC converter according to the present invention in comparison with the efficiency of a DC/DC converter according to a conventional technique.

From FIG. 8, it can be understood that, according to the conventional technique, the efficiency of the DC/DC converter decreases rapidly each time when a power reducing method (a limiting of the number of display colors or a partial display) at the LCD side is added. On the other hand, according to the present invention, it is possible to maintain the efficiency of the DC/DC converter always at an optimum level regardless of a normal operation time or a waiting time, by suitably applying a clock period to the power reducing method at the LCD side. In other words, according to the present invention, it is possible to prevent substantially completely the current consumption of the DC/DC converter that becomes unnecessary based on the application of each power saving method.

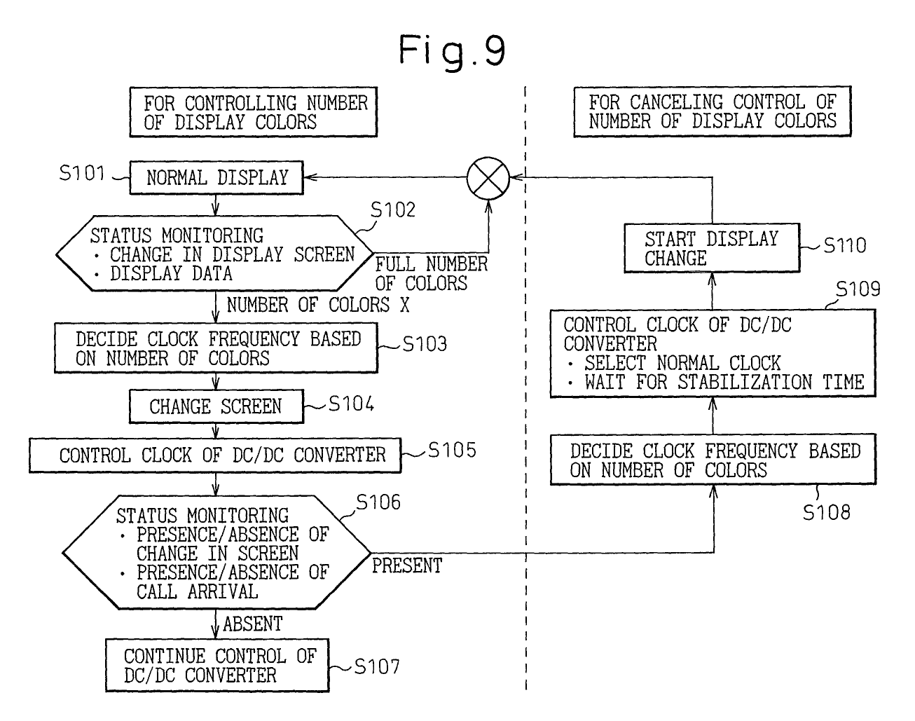

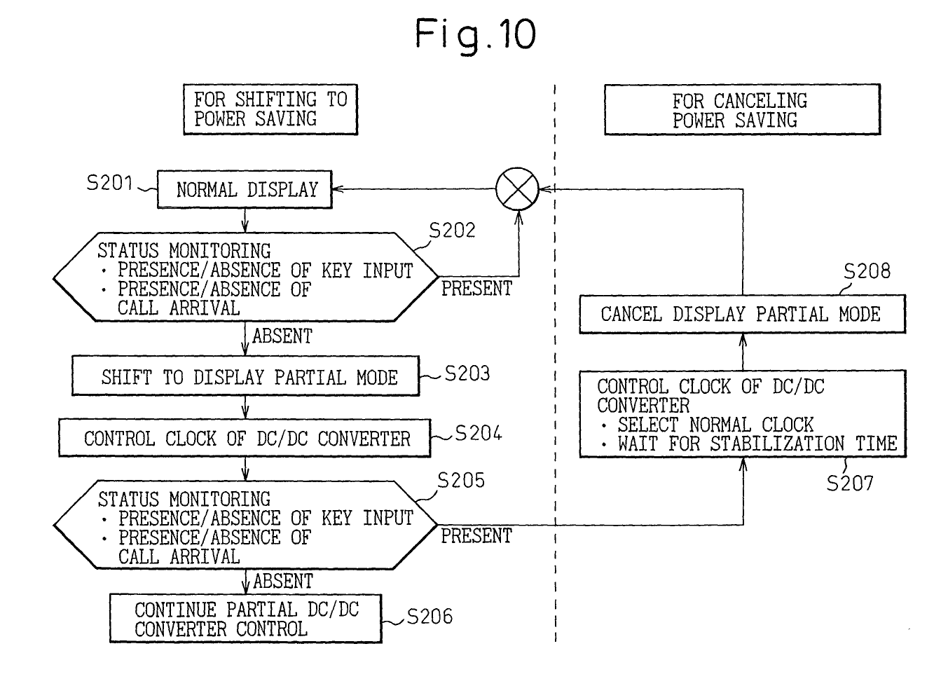

FIG. 9 and FIG. 10 show examples of control flows for switching an oscillation frequency executed by the CPU 13 (FIG. 4) according to the present invention. FIG. 9 is a flowchart showing one example of a process of limiting the number of display colors. FIG. 10 is a flowchart showing one example of a process of carrying out a partial display.

Referring to the flowchart of a process for limiting the number of display colors shown in FIG. 9, in the normal display status (S101), the CPU 13 is always or periodically monitoring a request for changing the display screen and display data of a picture or a text (S102). When the number of display colors has been limited to a predetermined number X, the CPU 13 decides a clock frequency corresponding to the number of colors X, based on a searching of an internal table or a predetermined calculation (S103).

Next, the CPU 13 changes the number of colors on the screen to the number of colors X, and at the same time, switches the clock of the DC/DC converter to the decided clock frequency (S104 and S105). In this waiting status, the CPU 13 is monitoring the presence or absence of a request for changing the display screen or a call arrival from other parties (S106). When a call has arrived, for example, the CPU 13 obtains a clock frequency to be returned to the normal time from the clock frequency based on the current number of clocks X, and a time required for stabilizing for the return. Then, the CPU 13 starts the processing of changing the display colors, based on this operation (S108 to S110).

Referring to the flowchart of a process for carrying out a partial display shown in FIG. 10, in the normal display status (S201), the CPU 13 is always or periodically monitoring the presence or absence of a key input, or the presence or absence of a call arrival (S202). When it is not possible to detect this during a predetermined time, the CPU 13 shifts to a partial display mode, and at the same time, switches the clock of the DC/DC converter to a corresponding clock frequency (S203 and S204). During this waiting status, the CPU 13 is also monitoring the presence or absence of a key input, or the presence or absence of a call arrival (S205). When a key input has been detected, for example, the CPU 13 selects the normal clock, and cancels the partial display based on a stabilization time for the return (S207 and S208).

In the present example, the LC type analog oscillation circuit has been explained as the clock source for supplying a clock to the DC/DC converter. However, it is also possible to use other digital oscillation circuit, and it is possible to use a PLL circuit in parallel. Further, in the above embodiment, only the sampling period of the DC/DC converter is made variable. It is also possible to switch the time constant of the sample holding circuit at the DC/DC converter step-up output side by matching this period, thereby to obtain more stable DC output.

As described above, according to the present invention, it is possible to achieve a further reduction in power consumption by limiting the number of display colors or based on a partial display of the LCD display unit, without lowering the efficiency of the DC/DC converter. The DC/DC converter is used always in maximum efficiency regardless of the display status of the normal operation mode or the waiting mode. Therefore, the invention greatly contributes to a reduction in power consumption in the mobile communication portable terminal or the portable information communication terminal in which power saving it is difficult to achieve.

What is claimed is:

1. A portable terminal equipped with a display unit, the portable terminal comprising:
a DC/DC converter for supplying power to the display unit;
a frequency switching unit for selectively switching and supplying one of a plurality of switching clock frequencies to the DC/DC converter; and
a display mode detecting unit for detecting that the display unit has been switched to a predetermined low-power consumption mode, determining one of the plurality of switching clock frequencies according to power consumption reduced in the predetermined low-power consumption mode based on this detection, and instructing the frequency switching unit to execute this selective switching.

2. The portable terminal according to claim 1, wherein
the display mode detecting unit determines lower one of the plurality of switching clock frequencies, when the display unit has been switched to a lower-power consumption mode.

3. A method of reducing power consumption of a portable terminal equipped with a display unit to which power is supplied from a DC/DC converter, the method comprising the steps of:
monitoring the display unit to see whether the display unit is in a display color number limiting mode or not;
determining a switching clock frequency of the DC/DC converter according to power consumption reduced by a reduction in the number of display colors, when the display color number limiting mode has been detected; and
switching the frequency to the determined switching clock frequency, and operating the DC/DC converter at this frequency.

4. A method of reducing power consumption of a portable terminal equipped with a display unit to which power is supplied from a DC/DC converter, the method comprising the steps of:
monitoring the display unit to see whether the display unit is in a partial display mode or not;
determining a switching clock frequency of the DC/DC converter according to power consumption reduced by a reduction in a display area, when the partial display mode has been detected; and
switching the frequency to the determined switching clock frequency, and operating the DC/DC converter in this frequency.

5. The portable terminal according to claim 1 or 2, wherein
the display unit is an LCD display unit.
